(19) United States
(12) Patent Application Publication
(10) Pub. No.: US 2023/0131679 A1
(43) Pub. Date: Apr. 27, 2023

(54) METHOD OF AUTOMATIC CHARACTERIZATION AND REMOVAL OF PAD ARTIFACTS IN ULTRASONIC IMAGES OF WELLS

(71) Applicant: Petróleo Brasileiro S.A. - Petrobras, Rio de Janeiro (BR)

(72) Inventors: Fernando Antonio Moreira Da Silva, Rio de Janeiro (BR); Mario Germino Ferreira Da Silva, Rio de Janeiro (BR); Patricia Braga Gusmao, Rio de Janeiro (BR); Valtair Marcos Cristante, Rio de Janeiro (BR)

(21) Appl. No.: 17/971,875

(22) Filed: Oct. 24, 2022

(30) Foreign Application Priority Data
Oct. 25, 2021 (BR) 10 2021 021447 3

(51) Int. Cl. G06T 5/00; G06T 5/20

(52) U.S. Cl. CPC G06T 5/002; G06T 5/20; G06T 2207/10132; G06T 2207/20056

(57) ABSTRACT

The present invention presents a method of automatic characterization and removal of marks and pad artifacts in ultrasonic images of reservoir wells. The method demonstrates the effectiveness of automatic characterization of this noise and its removal by modeling a two-dimensional square wave signal, periodic in the angular axis of the image, and includes: the obtention of the average curve of the one-dimensional power spectrum of the well image for the automatic detection of the artifact noise frequency response peak; the derivation of the geometric parameters of the signal of the artifacts by means of the frequency peak estimated in the previous step; the automatic modeling of the signal of the artifact as a periodic square wave using the parameters obtained in the previous steps; the processing of the original image using the square wave model filter obtained in the previous step.

### FIELD OF THE INVENTION

The present invention addresses to a method of removing artifacts (noise) in well ultrasonic images capable of preserving the geological and lithological information present therein.

### DESCRIPTION OF THE STATE OF THE ART

The characterization of hydrocarbon reservoirs is a task of vital importance for petrophysics in terms of determining the feasibility of exploring a basin or a reservoir well. It is for this purpose that various data are obtained from the soil of the reservoir, so that the geological, lithological and physical characteristics of the surroundings of the possible location of the reservoir can be mapped. Among the various mechanisms for geological characterization and obtaining petrophysical data from reservoirs, the drilling of reservoir logging wells stands out.

These wells are created by directly drilling the soil at the location of the reservoir (prior analysis of seismic, gravitometry and/or other data to determine the location most likely to contain hydrocarbons), and are intended for measuring petrophysical and geological properties of the same (and not the extraction of hydrocarbon itself). For said drilling, it is necessary to use special drillers and bits, which incorporate several telemetric systems designed to monitor physical variables that interfere in the drilling process (temperature, pressure, etc.).

During the drilling of wells, it is common to use tools to map various physical properties of the wall and of a certain degree of depth within the wall of the well. The most commonly mapped properties are nuclear properties related to natural radiation from reservoir formations (gamma rays, neutron porosity, natural radioactivity, gamma ray spectroscopy, etc.), electrical properties (spontaneous potential, resistivity, electromagnetic propagation), responses to magnetic resonance (NMR) stimulus and acoustic properties.

Among all these tools, it is worth highlighting the imaging of acoustic impedance of the well wall. This type of tool allows the generation of images that capture mechanical properties of the reservoir and the drilled well. These mechanical properties are related to characteristics such as density, packing, geology and lithology of the mapped formations, among others.

Due to the operating cost of using these tools, it is common to use tools that allow mapping more than one property at the same time. Some of these instruments, such as the well electrical resistivity imaging tool, contain position stabilization elements that ensure that the tool is always in a specific position (or at a specific absolute or relative distance as a function of the center of the tool itself) of the well wall, so that the measurement quality can be guaranteed.

These stabilizing elements necessarily come into contact with the well wall. Depending on the type of lithology present in the formation, it is common for them to leave marks on the well wall, which can be observed in image data obtained later by other tools, such as acoustic impedance imaging.

The aforementioned marks are harmful to the image data captured in these tools, since they introduce information that is not related to the geological and lithological properties to be mapped by the tool. This information, in fact, ends up masking the relevant information on the formation, often making the interpretation of the properties of certain regions of the data extremely complicated and controversial.

US patent 20140205201A1, owned by Schlumberger Technology, and titled “Cyclic noise removal in borehole imaging”, describes a method of removing cyclic noise, not specifically from vertical pads, by applying a filter in Fourier 2D space. This method is based on the manual characterization and modeling of noise (artifacts) in the power spectrum of the images, which means that it cannot be considered an automatic pad characterization method, as proposed in this document.

U.S. Pat. No. 9,250,060B2 discloses an optical coherence tomography system with real-time saturation and artifact correction that includes an optical coherence tomography unit, and a signal processing and visualization system adapted to communicate with the tomography unit of optical coherence, in order to receive the image signals coming from the same.

U.S. Pat. No. 4,935,904A discloses a method for removing artifacts generated at synthetic and real boundaries in seismic data. After seismic data processing, undesirable artifacts generated at the boundaries appear in the final seismic section. To remove this unwanted noise from the section, zeros are added to the lower boundary of the seismic section, essentially pushing the noise sources down in time into the section.

U.S. Pat. No. 6,215,841B1 discloses an artifact reduction system in the formation of three-dimensional images. More specifically, a 3D imaging algorithm is used to generate a composite contour profile of the object. In one embodiment, the composite boundary profile is determined by selecting a suitable boundary intensity level.

U.S. Pat. No. 9,245,320B2 discloses methods and systems for correcting artifacts in iterative reconstruction processes. Weighting schemes are applied so that less than all available sweep or projection data are used in the iterative reconstruction. In this way, inconsistencies in the data being reconstructed can be reduced.

Both of the above presented documents of prior art disclose technologies for noise reduction/removal in images generated by data collection; however, none of them is applied directly in removing pad marks and artifacts in ultrasonic images of reservoir wells. In addition to the presented state of the art, previous methods make use of an additional tool to be inserted into the well for the exclusive detection of formations during drilling.

In view of the difficulties present in the above-mentioned state of the art, and for solutions for the automatic characterization and removal of pad artifacts in ultrasonic images of wells, the need arises to develop a technology capable of performing effectively and in accordance with environmental and safety guidelines. The above-mentioned state of the art does not have the unique features that will be presented in detail below.

### OBJECTIVE OF THE INVENTION

It is an objective of the invention to provide a method of automatically removing pad mark artifacts from reservoir well images.

It is further an objective of the invention not to make use of any other well tool, so it does not imply any extra cost to the exploratory project.

It is further an objective of the invention to provide the specialist in the analysis of reservoir data with the ability to recover the relevant geological and lithological information from the images that are masked by the artifacts themselves, thus contributing to the improvement of the quality of the results obtained in the analysis itself and in the reservoir characterization process.

### BRIEF DESCRIPTION OF THE INVENTION

The present invention presents a method of characterization and automatic removal of pad marks and artifacts in ultrasonic images of reservoir wells. The method demonstrates the effectiveness of automatic characterization of this noise and its removal by modeling a two-dimensional square wave signal, periodic in the angular axis of the image, and includes: the obtention of the average curve of the one-dimensional power spectrum of the well image for the automatic detection of the artifact noise frequency response peak; the derivation of the geometric parameters of the signal of the artifacts by means of the frequency peak estimated in the previous step; the automatic modeling of the signal of the artifacts as a periodic square wave using the parameters obtained in the previous steps; the processing of the original image using the square wave model filter obtained in the previous step.

### BRIEF DESCRIPTION OF THE DRAWINGS

The present invention will be described in more detail below, with reference to the attached figures which, in a schematic form and not limiting the inventive scope, represent examples of its embodiment. In the drawings, there are:

FIG. 1 illustrates an example of the method of automatic detection of pad repetition period, a necessary step for the automatic modeling of the filter and the characterization of the artifacts;

FIG. 2 illustrates a detail of the modeling of a square pulse with unity amplitude, between the interval [−b, +b];

FIG. 3 illustrates the process by which the pad artifacts that appear in the analyzed ultrasonic images can be modeled using a periodic square wave on the angular (horizontal) axis of the well wall, repeated vertically for a certain depth;

FIG. 4 illustrates an example of the frequency response of a filter generated using the technique proposed in this document, for a specific case of pad artifact composition. The magnitude is shown above and the phase below;

FIG. 5 illustrates four examples of the final result of the method, where it is possible to visualize the original image with the artifacts, next to the data processed using the method, with the artifacts removed and the geological information preserved.

### DETAILED DESCRIPTION OF THE INVENTION

There follows below a detailed description of a preferred embodiment of the present invention, by way of example and in no way limiting. Nevertheless, it will be clear to a technician skilled on the subject, from reading this description, possible further embodiments of the present invention still comprised by the essential and optional features below.

The present invention provides a new method for overcoming the limitations of the state of the art for removing pad mark artifact noise in ultrasonic impedance imaging in reservoir wells. Furthermore, it also introduces a method of automatic characterization and modeling of this type of noise. There follows the detailed description of the method presented herein, by way of exemplification, referring to the figures.

Due to the fact that the method is based on image data that are usually obtained in well drilling maneuvers, it is not necessary to use additional resources to perform this task.

The method presented here uses acoustic impedance image data as input to characterize the noise of pad marks artifacts, by automatically modeling these artifacts as a periodic square wave on the horizontal axis. This modeling allows specific noise removal from the marks by filtering the model equation and the original image.

This method assumes carrying out a load of the data to be processed, by any method. Usually, this data is stored in files in DLIS or LAS format. It is not the purpose of this method to describe the method used to read/modify/write this type of files, but it is important to consider that this previous step of importing data will be necessary to use the method. The method requires the following steps:

### Step 1

Automatic obtention of the period value of the pad marks. This step should only be applied to data with a complete azimuthal sweep, that is, data that has been obtained after sweeping 360° of the well wall and not just a portion of the same. For this purpose, it will be necessary to obtain the magnitude of the one-dimensional spectrum of the Fourier transform of each of the lines of the input image. Once the spectra are calculated, it will be necessary to calculate the average by frequency for all the lines, thus obtaining the average of the one-dimensional spectrum for all the lines of the image. The location of the peak in this distribution characterizes the frequency of pad marks. This process is exemplified in FIG. 1, and the calculation can be performed by applying equation (1):

$${ω}_{x} = {argmax}_{∀ x} \vert \frac{1}{{N}_{y}} {\sum }_{n = 0}^{{N}_{y} - 1} {fft}_{1 D} ( {I}_{n} ) \vert \qquad ( 1 )$$

where I represents the acoustic impedance image to be processed, n is the line index of the image (from 0 to the total size of lines minus 1), N_{y} represents the total number of lines in the image, x represents the angular indices of the image (number of columns of the image) and ωₓ represents the repetition frequency of the pads.

### Step 2

Modeling of pad artifacts as a periodic square wave on the azimuthal axis. A square pulse with unity amplitude in the closed interval [−b, +b], as shown in FIG. 2, can be expressed according to equation (2):

$${f}_{x} = \{ \begin{matrix}1 & - b \leq x \leq + b \\ 0 & another value of x\end{matrix} \qquad ( 2 )$$

where f represents the equation that defines the pulse amplitude.

FIG. 3 shows how it is possible to use the definition shown in (2) to define a square wave as the infinite summation of square pulses spaced a certain constant value, as expressed according to equation (3):

$${g}_{x , y} = {\sum }_{k = - ∞}^{∞} f ( x - \frac{2 bk}{D} , y ) \qquad ( 3 )$$

where g_{x,y} represents the equation that defines the amplitude of the periodic square wave in x, f is given by equation (2), x represents the angular indices of the image (number of columns of the image), y represents the vertical indices (number of lines of the image), k is the index of each of the pulses that make up the signal (theoretically from −∞ to +∞), and D represents the proportion between the spacing between the pulses and the size of the pulse, also called “duty cycle” (a perfect square wave with equal spacing has a value of D=0.5).

By applying the discrete Fourier transform, it is possible to obtain the equivalent equation, in the frequency space, of (3), which is given by equation (4):

$${H}_{{ω}_{x} , {ω}_{y}} = \sqrt{\frac{2}{π}} \frac{sin ( {ω}_{x} D \frac{N}{{N}_{p}} )}{{ω}_{x}} {\sum }_{k = 0}^{{N}_{p} - 1} {e}^{- j {ω}_{x} \frac{N}{{N}_{p}} ( \frac{D}{2} + k )} δ ( {ω}_{y} ) \qquad ( 4 )$$

where H_{ω}_{ₓ}_{,ω}_{_{y}} represents the equation defining the two-dimensional square wave given by (3) in the frequency space defined by ωₓ and ω_{y} (horizontal and vertical frequency components, respectively), and Nₚ is the number of pads, which can be calculated from the image size (number of columns) and the frequency of the pads obtained according to (1).

The value of D is a constant for the entire well that depends on the tool used. This information is accessible by means of the tool catalogs offered by their manufacturers and can be derived from the information on said tool obtained during the data import. The value can also be modified by the user when applying the method and, in case of indeterminacy, it can be considered D=0.5.

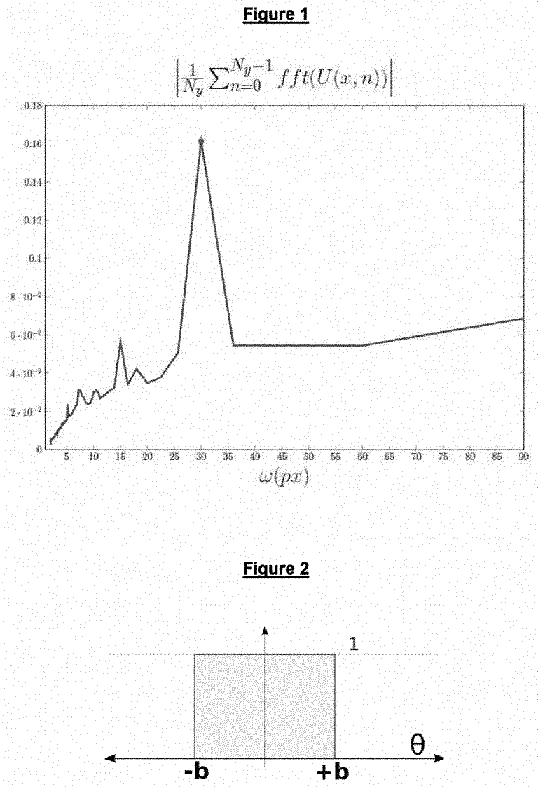

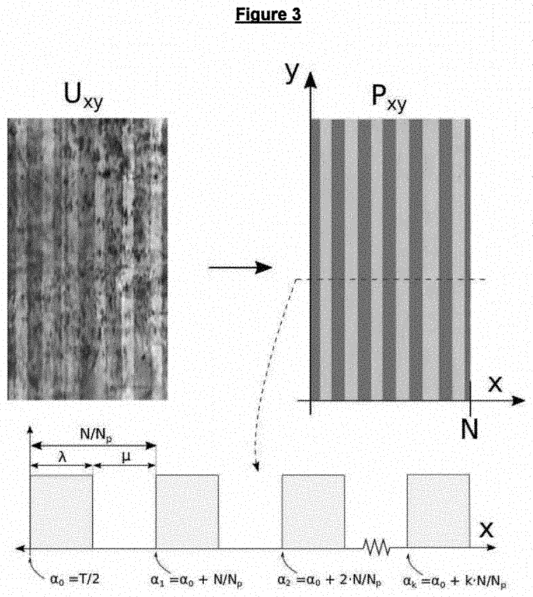

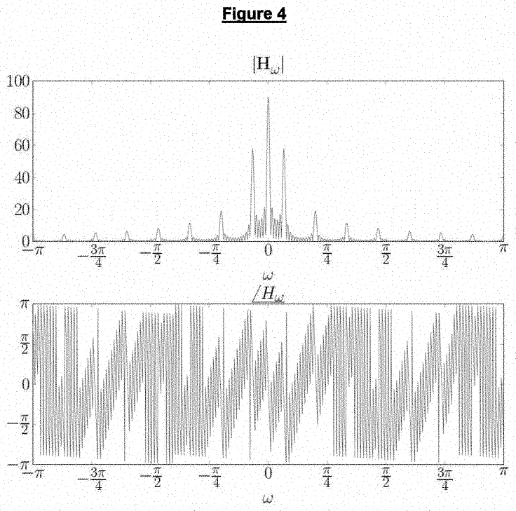

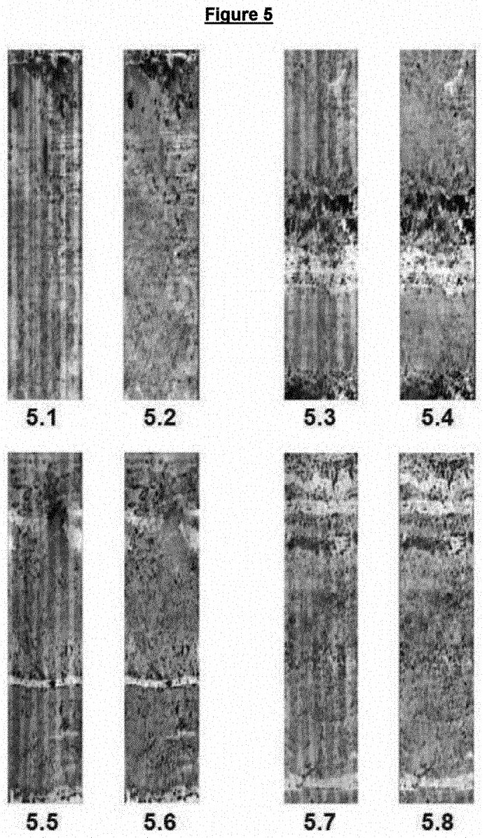

An example of the frequency response of the filter defined in equation (4) can be seen in FIG. 4. In this figure, the upper part shows the magnitude of this response, while the lower part shows the phase.

### Step 3

Application of the filter by multiplying the wave model (4) and the two-dimensional Fourier transform of the input image.

### Step 4

Obtaining the final image processed by applying the inverse two-dimensional Fourier transform to the result obtained in Step 3. FIG. 5 shows an actual example of the result obtained by processing by this method in ultrasonic impedance images of reservoir wells. In it, the original data are shown in 5.1, 5.3, 5.5, and 5.7, whereas the processed data, after applying the method shown here, appear in 5.2, 5.4, 5.6, and 5.8, respectively.

The invention disclosed herein is capable of being applied to a tool that performs amplitude measurements by a transducer of emission and reception of ultrasonic waves. It is also capable of being applied to boreholes for any type of reservoir and without casing.

Those skilled in the art will immediately appreciate the important benefits arising from the use of the present invention. This method does not require the use of any other well tool, so it does not incur any extra cost to the exploratory project. Furthermore, the ability to recover geological and lithological information masked by pad artifacts, due to the use of other well property mapping tools, increases not only the usability of the data in automatic methods (such as, for example, application of the data to characterization processes, classification, use of neural networks, texture detectors, etc.), but also improves the robustness and reliability of the results and the information that can be concluded and extracted therefrom by the specialists who analyze the same.

1. A method of automatic characterization and removal of pad artifacts in ultrasonic images of wells characterized in that it comprises the following steps:
1) Automatic obtention of the period value of the pad marks;
2) Modeling of pad artifacts;
3) Application of a filter; and
4) Obtaining the final processed image.

2. The method according to claim 1, characterized in that Step 1 is only applied to data with a complete azimuthal sweep, after sweeping 360° of the well wall.

3. The method according to claim 2, characterized in that it additionally obtains the magnitude of the one-dimensional spectrum of the Fourier transform of each of the lines of the input image.

4. The method according to claim 3, characterized in that it calculates the average by frequency for all lines, thus-thereby obtaining the average of the one-dimensional spectrum for all lines of the image.

5. The method according to claim 1, characterized in that Step 2 is a periodic square wave on the azimuthal axis, a square pulse with unit amplitude in the closed interval [−b, +b].

6. The method according to claim 5, characterized in that it defines a square wave as the infinite summation of spaced square pulses of a certain constant value.

7. The method according to claim 6, characterized in that it applies the discrete Fourier transform to the square wave.

8. The method according to claim 1, characterized in that, in Step 3, a filter is applied by multiplying the wave model and the two-dimensional Fourier transform of the input image.

9. The method according to claim 1, characterized in that, in Step 4, it obtains the final image processed by applying the inverse two-dimensional Fourier transform to the result obtained in Step 3.

10. The method according to claim 1, characterized in that it is applied to a tool that performs amplitude measurements by a transducer of emission and reception of ultrasonic waves.

11. The method according to claim 1, characterized in that it is applied to boreholes for any type of reservoir and without casing.
